(19) United States
(12) Patent Application Publication
(10) Pub. No.: US 2017/0200132 A1
(43) Pub. Date: Jul. 13, 2017

(54) CONTENT AND CONTEXT AWARE REMINDERS TO TAKE ACTION ON NOTES

(71) Applicant: International Business Machines Corporation, Armonk, NY (US)

(72) Inventors: Adrian B. Jordan, Morrisville, NC (US); Joseph N. Kozhaya, Morrisville, NC (US); Michael T. Peters, Morrisville, NC (US); David S. Richardson, Morrisville, NC (US); Teppei Tsurumi, Cary, NC (US)

(21) Appl. No.: 14/992,546

(22) Filed: Jan. 11, 2016

(51) Int. Cl. G06Q 10/10; G06F 17/28; G06F 17/27

(52) U.S. Cl. CPC G06Q 10/1097; G06F 17/2705; G06F 17/2775; G06F 17/28

(57) ABSTRACT

A computer program product for generating content and context aware reminders for a user to take action on notes is provided. The computer program product includes a computer readable storage medium having program instructions embodied therewith. The program instructions are readable and executable by a processing circuit to cause the processing circuit to receive a user command to generate a note comprising note text relating to an action to be taken by the user, analyze the note text to find categorically identifiable keywords and temporal signatures, respectively associate the categorically identifiable keywords and temporal signatures with corresponding physical locations and corresponding times and remind the user to take the action based on one or more of spatial correlations between a current user location with the physical locations corresponding to the categorically identifiable keywords and temporal correlations between a current time and the times corresponding to the temporal signatures.

### BACKGROUND

The present invention relates to content and context aware reminders and, more specifically, to content and context aware reminders for a user to take action on notes.

Often times, people generate for themselves notes for various to-do or action items that require their attention at some point in time but then forget about the notes and fail to associate current circumstances (i.e., driving destinations) with to-do completion. As such, applications have been built to assist users in making their notes or completing their to-do tasks.

For example, one application currently available allows a user to specify a location on a map and associate it with a task from a to-do list. However, this application does not automatically create associations between the text in the notes and the physical locations. Another available system provides for rich context surrounding a reminder but requires that the user generates the rich content himself. That is, when creating a reminder, the user is prompted with a dynamically generated list of “sub-situations” that are selectable and editable into the rich content. A memory aid for the elderly is also available and allows for the posting, triggering and delivery of reminders. The triggers can be temporal, location-based or people-based but again relies upon user input associations between reminders and physical locations.

### SUMMARY

According to an embodiment of the present invention, a computer program product for generating content and context aware reminders for a user to take action on notes is provided. The computer program product includes a computer readable storage medium having program instructions embodied therewith. The program instructions are readable and executable by a processing circuit to cause the processing circuit to receive a user command to generate a note comprising note text relating to an action to be taken by the user, analyze the note text to find categorically identifiable keywords and temporal signatures, respectively associate the categorically identifiable keywords and temporal signatures with corresponding physical locations and corresponding times and remind the user to take the action based on one or more of spatial correlations between a current user location with the physical locations corresponding to the categorically identifiable keywords and temporal correlations between a current time and the times corresponding to the temporal signatures.

According to another embodiment of the present invention, a computing system for generating content and context aware reminders for a user to take action on notes is provided. The computing system includes a computer readable storage medium having instructions stored thereon that are executable by a processing circuit to cause the processing circuit to receive a user command to generate a note comprising note text relating to an action to be taken by the user, analyze the note text to find categorically identifiable keywords and temporal signatures, respectively associate the categorically identifiable keywords and temporal signatures with corresponding physical locations and corresponding times and remind the user to take the action based on one or more of spatial correlations between a current user location with the physical locations corresponding to the categorically identifiable keywords and temporal correlations between a current time and the times corresponding to the temporal signatures.

According to yet another embodiment of the present invention, a computer-implemented method for generating content and context aware reminders for a user to take action on notes is provided and includes receiving a user command to generate a note comprising note text relating to an action to be taken by the user, analyzing the note text to find categorically identifiable keywords and temporal signatures, respectively associating the categorically identifiable keywords and temporal signatures with corresponding physical locations and corresponding times and reminding the user to take the action based on one or more of spatial correlations between a current user location with the physical locations corresponding to the categorically identifiable keywords and temporal correlations between a current time and the times corresponding to the temporal signatures.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of a computing system in accordance with embodiments;

FIG. 2 is a schematic illustration of a first computing device of the computing system of FIG. 1;

FIG. 3 is a schematic illustration of a computer program product for generating content and context aware reminders for a user to take action on notes;

FIG. 4 is an exemplary illustration of a user generated note;

FIG. 5 is a graphical depiction of a respective association of note text to a stored map;

FIG. 6 is an exemplary illustration of a user generated note with keyword and temporal limitations;

FIG. 7 is a graphical depiction of a respective association of note text to a stored map while taking into account the keyword and temporal limitations;

FIG. 8 is a flow diagram illustrating a deployment process of the computer program product of FIGS. 3-7; and

FIG. 9 is a flow diagram illustrating a computer-implemented method for generating content and context aware reminders for a user to take action on notes.

### DETAILED DESCRIPTION

As will be described below, text of notes created by a user (e.g., in a to-do list or some other similar note or application) is automatically analyzed and mapped to a set of locations and/or times of where and when those to-do items should be done. The user is then automatically reminded of those items when he is in the vicinity of the identified locations and/or at the same time during correct environmental conditions.

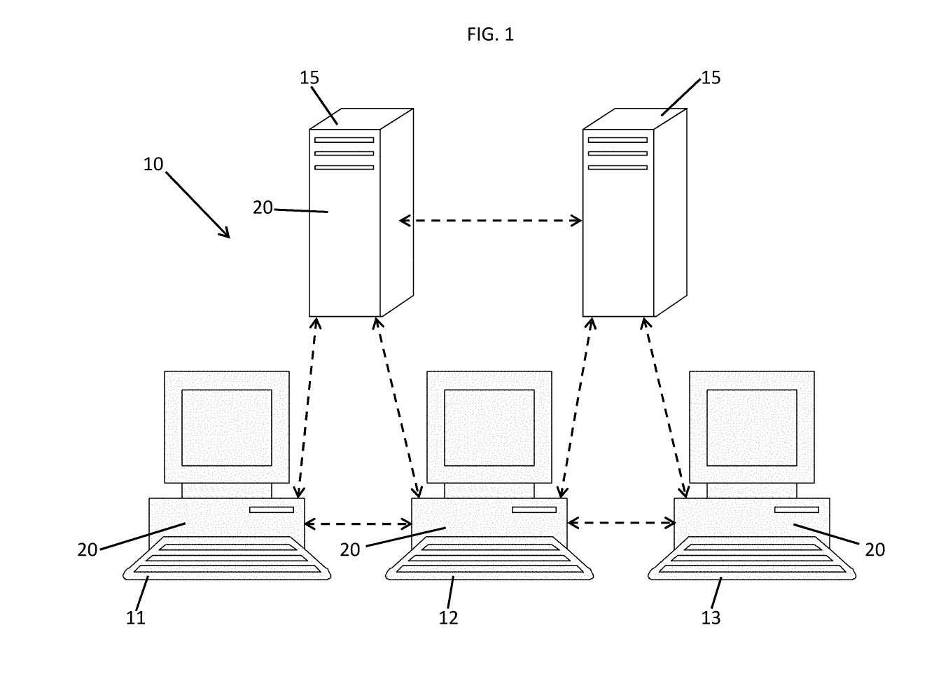

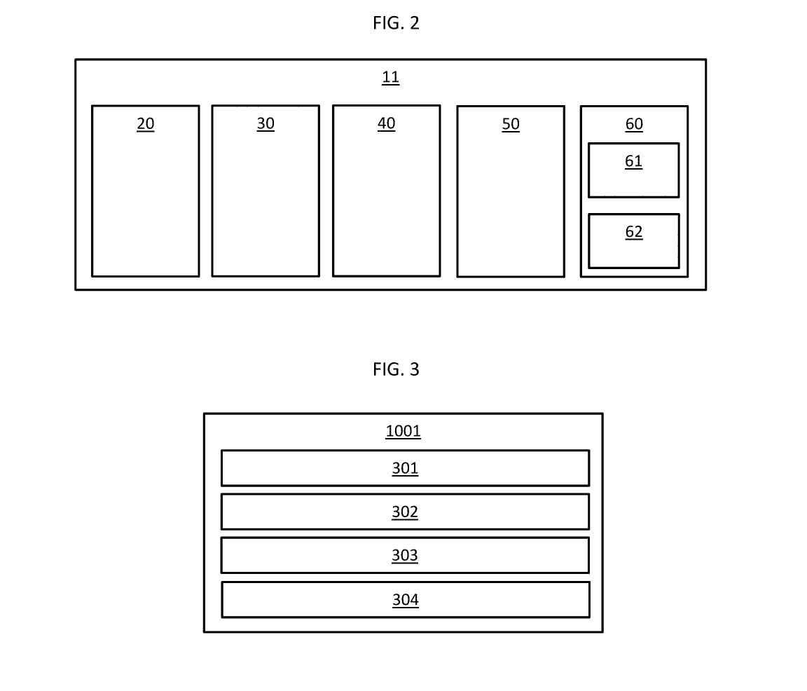

With reference to FIGS. 1 and 2, a computing system 10 is provided and may be configured for example as an enterprise computing system or as a personal computing system. In either case, the first computing system 10 includes first, second and third computing devices 11, 12 and 13 and servers 15 which are configured to be networked together for communication purposes. As shown in FIG. 2, each of the first, second and third computing devices 11, 12 and 13 and the servers 15 may include among other features a processing circuit 20, a display 30, user input devices 40, a networking unit 50 and a memory unit 60 on which first and second computer program products 61 and 62 are stored. The first computer program product 61 may be any type of user generated note or reminder application and allows users to generate note or reminders for themselves. Such notes include textual and/or temporal clues that relate to a type of a reminder the user is generating and a time period during which reminder is active or effective. The second program product 62 is configured for generating content and context aware reminders for a user to take action on notes, such as the notes or reminders generated by way of the first computer program product 61.

In accordance with embodiments, each of the first, second and third computing devices 11, 12 and 13 may be a mobile computing device such as, for example, a laptop computer, a tablet, a smartphone or any other similar portable computing element.

The processing circuit 20 may be provided as a micro-processor, a central processing unit (CPU) or any other suitable processing device. The display 30 may be provided as a monitor and is configured to display data and information as well as a graphical user interface to an administrator or user. The user input devices 40 may be provided as a mouse and a keyboard combination and are configured to allow the administrator or user to input commands to the processing circuit 20. The networking unit 50 may be provided as an Ethernet or other suitable networking device by which the first, second and third computing devices 11, 12 and 13 and servers 15 are communicative. The memory unit 60 may be provided with various types of memory capacity, such as read only memory (ROM) capacity, random access memory (RAM) capacity and/or any other suitable storage capacity.

With reference to FIG. 3, the second computer program product 62 includes a computer readable storage medium 1001 and may be installed in the memory unit 60 of the computing device 11 (or any other computer device/server of the computing system 10) as firmware or as lower level executable program instructions. In any case, the second computer program product 62 may include first-fourth sequences of program instructions 301-304. The first sequence of program instructions 301 are executable by the processing circuit 20 to cause the processing circuit 20 to receive a user command to generate a note comprising note text relating to an action to be taken by the user. The second sequence of program instructions 302 are executable by the processing circuit 20 to cause the processing circuit 20 to automatically analyze the note text using natural language processing (NLP) or some other similar sub-routine or application to find categorically identifiable keywords and temporal signatures. The third sequence of program instructions 303 are executable by the processing circuit 20 to cause the processing circuit 20 to automatically respectively associate the categorically identifiable keywords and temporal signatures with corresponding physical locations and corresponding times. The fourth sequence of program instructions 304 are executable by the processing circuit 20 to cause the processing circuit 20 to automatically remind the user to take the action based on one or more of spatial correlations and temporal correlations. The spatial correlations may be defined as spatial correlations between a current user location as determined by a GPS sensor, or other suitable location determination means, of the computing device 11 with the physical locations corresponding to the categorically identifiable keywords. The temporal correlations may be defined as temporal correlations between a current time as determined by a clock element of the computing device 11 and the times corresponding to the temporal signatures.

In accordance with embodiments, the second sequence of program instructions 302 may cause the processing circuit 20 to analyze the note text to find keyword limitations by which numbers of the corresponding physical locations are reduced and/or temporal limitations by which the corresponding times are limited. Additionally, the fourth sequence of program instructions 304 may cause the processing circuit 20 to issue the reminders to the user based on environmental conditions as well as the spatial and temporal correlations. Such environmental conditions may include at least one or more of a user destination, user travel patterns, weather and urgency of the note text.

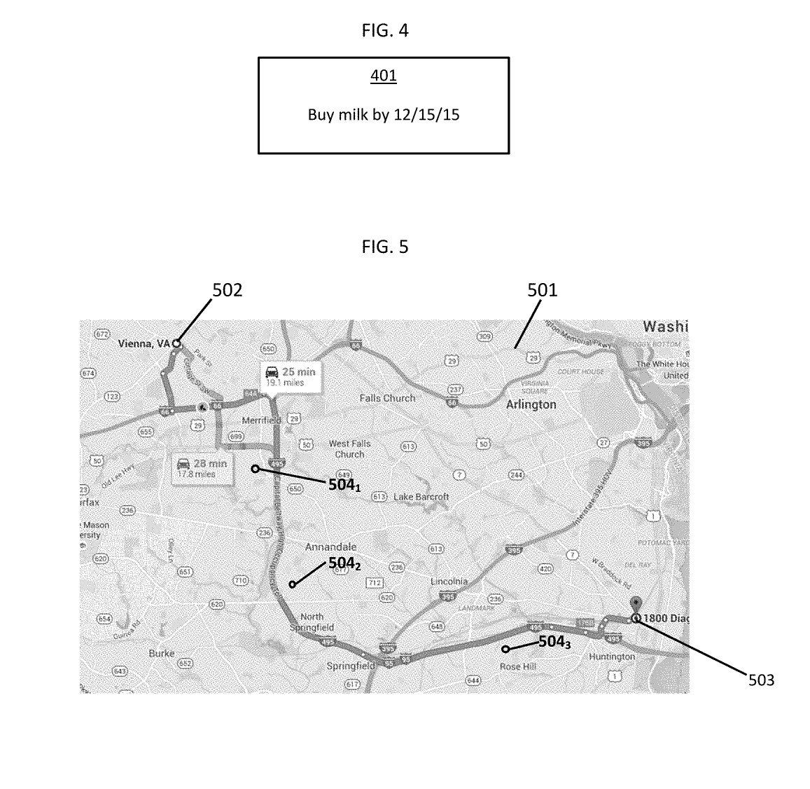

With reference now to FIGS. 4 and 5, an exemplary execution of the second computer program product 62 is illustrated and will be described below.

As shown in FIG. 4, the user of the first computing device 11 writes note 401 as a reminder to himself to “buy milk by 12/15/15” using the first computer program product 61. In the meantime and with the second computer program product 62 running concurrently, the first sequence of program instructions 301 of the second computer program product 62 is executed to receive a user command to generate the note 401 (where the note 401 includes the note text relating to the buying of milk by Dec. 15, 2015 as an action to be taken by the user) once the note 401 is saved or otherwise preserved in the memory unit 60. At this point, execution of the second sequence of program instructions 302 causes the processing circuit 20 to employ NLP or another similar program or algorithm to automatically analyze the note text to find categorically identifiable keywords and temporal signatures. In the exemplary case, the categorically identifiable keywords may be the terms “buy” and “milk,” while the temporal signatures may be the sequence of numbers and slashes that identifies the “12/15/15” as a date. Thus, the automatic analysis determines that the note text relates to some type of purchase by the user from the “buy” term, which is an indication that the action is outside his house or office, that the note text identifies the type of the purchase as being a grocery store purchase from the “milk” term and that the note text identifies the temporal signature as being a fulfill date.

With the automatic analysis completed, execution of the third sequence of program instructions 303 causes the processing circuit 20 to automatically respectively associate the categorically identifiable keywords and temporal signatures (i.e., the terms “buy” and “milk” and the recognition that “12/15/15” is a date) with corresponding physical locations and corresponding times. In doing so, the processing circuit 20 may refer to a stored map 501 on which the user's home 502 and office 503 are shown and then find and highlight first, second and third grocery stores 504₁, 504₂ and 504₃ in and around the user's home 502 or office 503 at which the user action underlying the “buy” and “milk” terms could be fulfilled. In addition, the processing circuit 20 may recognize that the date associated with the term “12/15/15” is actually Dec. 15, 2015 and thus determine that the “buy” and “milk” terms need to be fulfilled by Dec. 15, 2015.

The fourth sequence of program instructions 304 are then executable by the processing circuit 20 to cause the processing circuit 20 to automatically remind the user to take the action based on one or more of the spatial correlations and the temporal correlations as defined above. As such, if the current user location is determined to be proximal to, say, the second grocery store 504₂ and the current date is Dec. 14, 2015, the processing circuit 20 may automatically issue a reminder to the user to buy milk at the second grocery store 504₂.

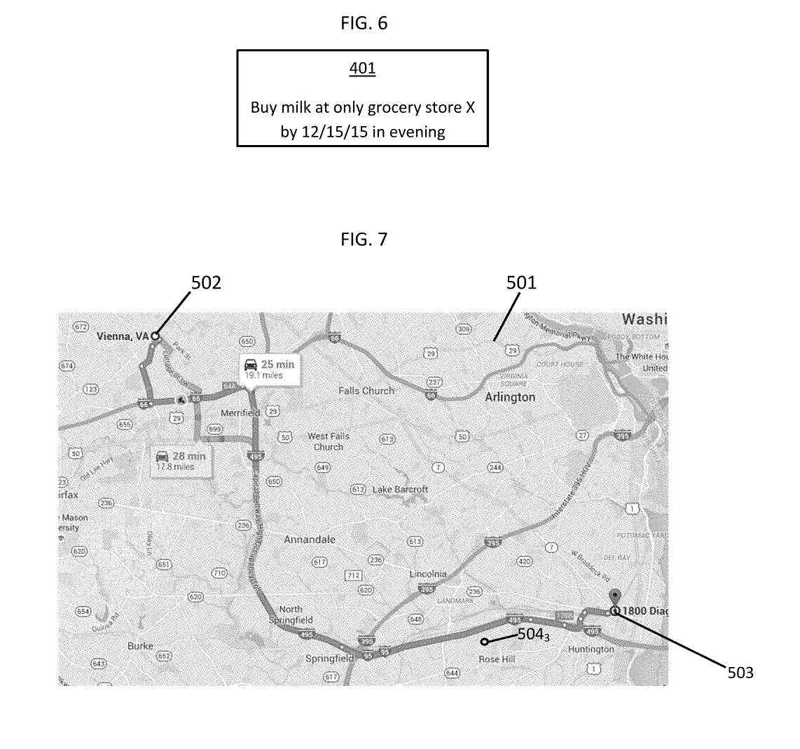

In accordance with further embodiments and, with reference to FIGS. 6 and 7, the second sequence of program instructions 302 may cause the processing circuit 20 to analyze the note text to find one or more of keyword limitations by which numbers of the corresponding physical locations are reduced and temporal limitations by which the corresponding times are limited. That is, if the note text included the phrase “buy milk at ‘only grocery store X’ by 12/15/15 ‘in evening’,” the execution of the second sequence of program instructions 302 causes the processing circuit 20 to employ NLP or another similar program or algorithm to automatically analyze the note text to find the categorically identifiable keywords and temporal signatures noted above and to find the keyword and temporal limitations “only grocery store X” and “in evening.” Thus, the automatic analysis and respective association proceed as described above but additionally determines that the note text limits the note's effect to only a certain grocery store and to only a certain time of day. As such, the processing circuit 20 only finds and highlights the third grocery store 504₃ (which the processing circuit 20 understands to be grocery store X) on the stored map 501 and, while recognizing, that the date associated with the term “12/15/15” is actually Dec. 15, 2015 such that the “buy” and “milk” terms need to be fulfilled by Dec. 15, 2015, the processing circuit further recognizes that the note should only have effect between 5-7 PM.

In this case, the fourth sequence of program instructions 304 are then executable by the processing circuit 20 to cause the processing circuit 20 to automatically remind the user to take the action based on one or more of the spatial correlations and the temporal correlations as defined above while taking into account the keyword and temporal limitations. As such, if the current user location is determined to be proximal to, say, the third grocery store 504₃ and the current date and time is Dec. 14, 2015 at 6 PM, the processing circuit 20 will issue a reminder to the user to buy milk at the third grocery store 504₃ However, if the current user location is determined to be proximal to, say, the second grocery store 504₂ or the current date and time is Dec. 14, 2015 at 9 AM, the processing circuit 20 will not issue any reminder to the user.

For any of the embodiments described above, the fourth sequence of program instructions 304 may cause the processing circuit 20 to issue the reminders to the user based on the environmental conditions as well as the one or more of the spatial and temporal correlations. Where such environmental conditions may include at least one or more of a user destination, user travel patterns, weather and urgency of the note text, a reminder to buy milk might only be issued to the user in a case where the user is traveling towards his home since the milk could be stored in his refrigerator at home before spoiling. Similarly, if the note text has a hard date included therein and exclamation points, the reminders may be sent well in advance of the hard date or may be appended with an “urgent” signifier.

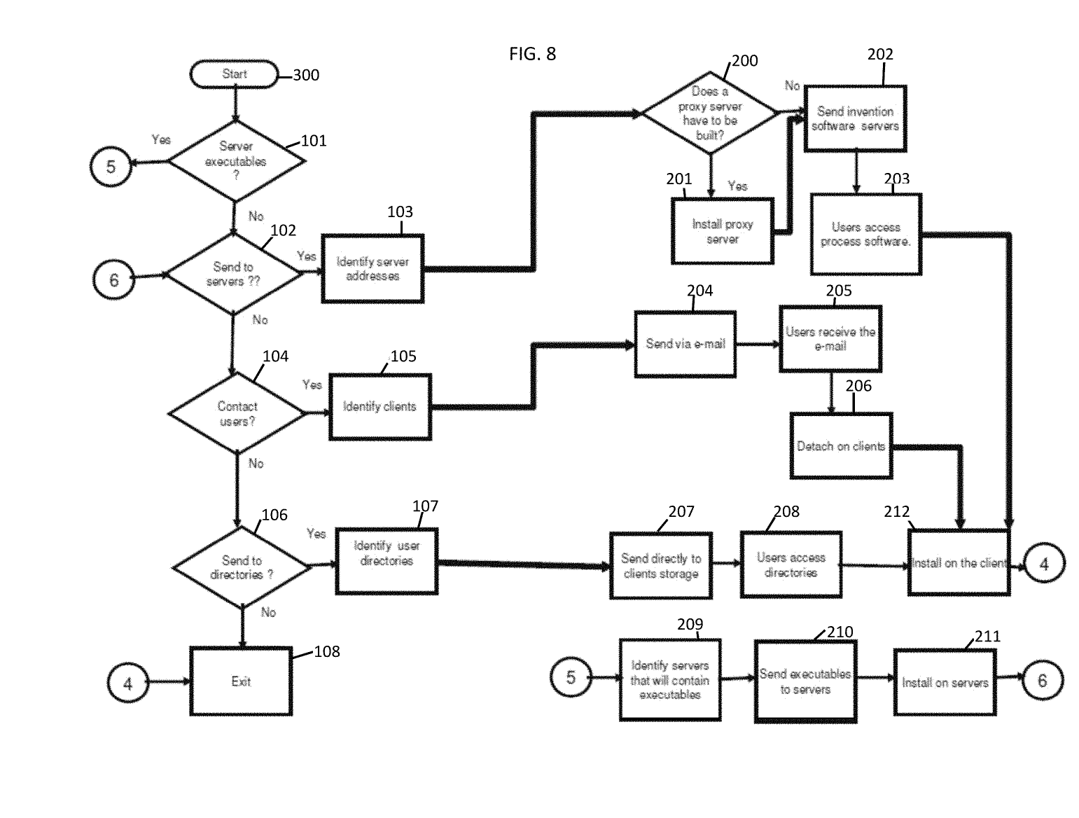

In accordance with embodiments and, with reference to FIG. 8, a deployment process of the second computer program product 62 described above is provided. The process begins at block 300 and at block 101 with a determination of whether the first-fourth sequences of program instructions 301-304 will reside on server 15 when executed. If so, then the server 15 is identified at block 209. The first-fourth sequences of program instructions 301-304 are then transferred directly to the server 15 storage via FTP or some other protocol or by copying though the use of a shared file system at block 210 such that the f first-fourth sequences of program instructions 301-304 are installed on the servers at block 211.

Next, a determination is made on whether the first-fourth sequences of program instructions 301-304 are to be deployed by having users access to the first-fourth sequences of program instructions 301-304 on server 15 at block 102. If so, the server 15 addresses that will store the first-fourth sequences of program instructions 301-304 are identified at block 103 and a determination is made if a proxy server is to be built at block 200 for storage. A proxy server is a server that sits between a client application, such as a Web browser, of first computing device 11 and server 15 and operates by intercepting all requests to the server 15 to see if it can fulfill the requests itself. If not, the proxy server forwards the request to server 15. The two primary benefits of a proxy server are to improve performance and to filter requests.

If a proxy server is required, then the proxy server is installed at block 201 and the first-fourth sequences of program instructions 301-304 are sent via a protocol, such as FTP, or by being copied directly from the source files to the server 15 files via file sharing at block 202. Another embodiment involves sending a transaction to the (one or more) server 15 that contained the process software, and have the server 15 process the transaction and then receive and copy the process software to the server 15 file system. Once the process software is stored, the users may then access the first-fourth sequences of program instructions 301-304 and copy to the same to their respective client computer file systems at block 203. Alternatively, the server 15 may automatically copy the first-fourth sequences of program instructions 301-304 to each client and then run an installation program for the first-fourth sequences of program instructions 301-304 on each client computer whereby the user executes the program that installs the first-fourth sequences of program instructions 301-304 on his client computer at block 212 and then exits the process at block 108.

At block 104, a determination is made as to whether the first-fourth sequences of program instructions 301-304 are to be deployed by being sent to users via e-mail. If a result of the determination is affirmative, the set of users are identified together with the addresses of the user client computers at block 105 and the first-fourth sequences of program instructions 301-304 are sent via e-mail to each of the users' client computers. The users then receive the e-mail at block 205 and detach the first-fourth sequences of program instructions 301-304 from the e-mail to a directory on their client computers at block 206. The user executes the program that installs the first-fourth sequences of program instructions 301-304 on his client computer at block 212 and then exits the process at block 108.

Lastly, a determination is made on whether the first-fourth sequences of program instructions 301-304 will be sent directly to user directories on their client computers at block 106. If so, the user directories are identified at block 107 and the process software is transferred directly to the user's client computer directories at block 207. This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the first-fourth sequences of program instructions 301-304 at block 208, execute the program that installs the first-fourth sequences of program instructions 301-304 at block 212 and then exit the process at block 108.

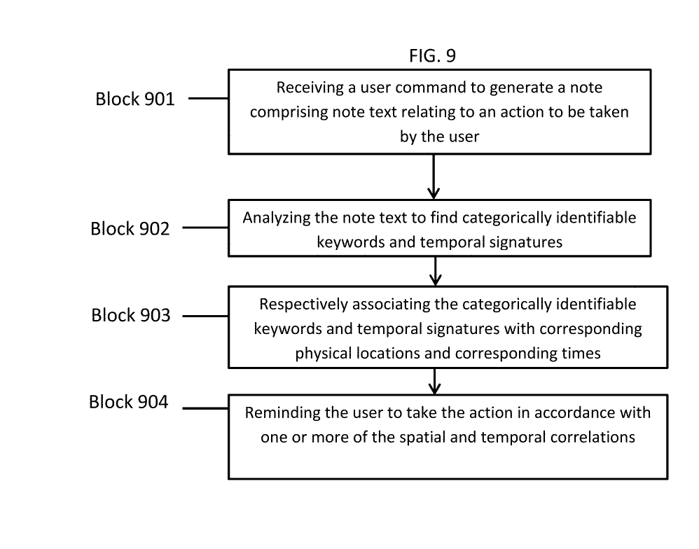

With reference to FIG. 9, a computer-implemented method for generating content and context aware reminders for a user to take action on notes is provided. The computer-implemented method includes receiving a user command to generate a note comprising note text relating to an action to be taken by the user at block 901, analyzing the note text to find categorically identifiable keywords and temporal signatures at block 902, respectively associating the categorically identifiable keywords and temporal signatures with corresponding physical locations and corresponding times at block 903 and reminding the user to take the action at block 904 based on one or more of the spatial and temporal correlations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product for generating content and context aware reminders for a user to take action on notes, the computer program product comprising a computer readable storage medium having program instructions embodied therewith, the program instructions being readable and executable by a processing circuit to cause the processing circuit to:
receive a user command to generate a note comprising note text relating to an action to be taken by the user;
analyze the note text to find categorically identifiable keywords and temporal signatures;
respectively associate the categorically identifiable keywords and temporal signatures with corresponding physical locations and corresponding times; and
remind the user to take the action based on one or more of:
spatial correlations between a current user location with the physical locations corresponding to the categorically identifiable keywords, and
temporal correlations between a current time and the times corresponding to the temporal signatures.

2. The computer program product according to claim 1, wherein an analysis of the note text, a respective association and a reminder are executed automatically.

3. The computer program product according to claim 1, wherein the program instructions cause the processing circuit to analyze the note text using natural language processing (NLP).

4. The computer program product according to claim 1, wherein the program instructions cause the processing circuit to analyze the note text to find keyword limitations by which numbers of the corresponding physical locations are reduced.

5. The computer program product according to claim 1, wherein the program instructions cause the processing circuit to analyze the note text to find temporal limitations by which the corresponding times are limited.

6. The computer program product according to claim 1, wherein the program instructions cause the processing circuit to remind the user based on environmental conditions and the spatial and temporal correlations.

7. The computer program product according to claim 6, wherein the environmental conditions comprise at least one or more of a user destination and user travel patterns.

8. A computing system for generating content and context aware reminders for a user to take action on notes, the computing system comprising a computer readable storage medium having instructions stored thereon that are executable by a processing circuit to cause the processing circuit to:
receive a user command to generate a note comprising note text relating to an action to be taken by the user;
analyze the note text to find categorically identifiable keywords and temporal signatures;
respectively associate the categorically identifiable keywords and temporal signatures with corresponding physical locations and corresponding times; and
remind the user to take the action based on one or more of:
spatial correlations between a current user location with the physical locations corresponding to the categorically identifiable keywords, and
temporal correlations between a current time and the times corresponding to the temporal signatures.

9. The computing system according to claim 8, wherein an analysis of the note text, a respective association and a reminder are executed automatically.

10. The computing system according to claim 8, wherein the instructions cause the processing circuit to analyze the note text using natural language processing (NLP).

11. The computing system according to claim 8, wherein the instructions cause the processing circuit to analyze the note text to find keyword limitations by which numbers of the corresponding physical locations are reduced.

12. The computing system according to claim 8, wherein the instructions cause the processing circuit to analyze the note text to find temporal limitations by which the corresponding times are limited.

13. The computing system according to claim 8, wherein the instructions cause the processing circuit to remind the user based on environmental conditions and the spatial and temporal correlations.

14. The computing system according to claim 13, wherein the environmental conditions comprise at least one or more of a user destination and user travel patterns.

15. A computer-implemented method for generating content and context aware reminders for a user to take action on notes, comprising:
receiving a user command to generate a note comprising note text relating to an action to be taken by the user;
analyzing the note text to find categorically identifiable keywords and temporal signatures;
respectively associating the categorically identifiable keywords and temporal signatures with corresponding physical locations and corresponding times; and
reminding the user to take the action based on one or more of:
spatial correlations between a current user location with the physical locations corresponding to the categorically identifiable keywords, and
temporal correlations between a current time and the times corresponding to the temporal signatures.

16. The computer-implemented method according to claim 15, wherein analyzing, the respectively associating and the reminding are automatic.

17. The computer-implemented method according to claim 15, wherein the analyzing comprises analyzing the note text using natural language processing (NLP).

18. The computer-implemented method according to claim 15, wherein the analyzing comprises analyzing the note text to find keyword limitations by which numbers of the corresponding physical locations are reduced.

19. The computer-implemented method according to claim 15, wherein the analyzing comprises analyzing the note text to find temporal limitations by which the corresponding times are limited.

20. The computer-implemented method according to claim 15, wherein the reminding comprises reminding the user based on environmental conditions and the spatial and temporal correlations, the environmental conditions comprising at least one or more of a user destination and user travel patterns.
